(19) United States
(12) Patent Application Publication
(10) Pub. No.: US 2014/0011083 A1
(43) Pub. Date: Jan. 9, 2014

(54) ELECTRODE FOR NON-AQUEOUS ELECTROLYTE SECONDARY BATTERIES AND NON-AQUEOUS ELECTROLYTE SECONDARY BATTERY INCLUDING THE SAME

(71) Applicant: SHARP KABUSHIKI KAISHA, Osaka (JP)

(72) Inventors: Isao ASAKO, Osaka (JP); Naoto NISHIMURA, Osaka (JP); Takahiro MATSUYAMA, Osaka (JP); Shumpei NISHINAKA, Osaka (JP); Motoaki NISHIJIMA, Osaka (JP); Hisayuki UTSUMI, Osaka (JP); Satoshi ARIMA, Osaka (JP)

(73) Assignee: SHARP KABUSHIKI KAISHA, Osaka (JP)

(21) Appl. No.: 13/927,522

(22) Filed: Jun. 26, 2013

(30) Foreign Application Priority Data
Jun. 28, 2012 (JP) 2012-145786

(51) Int. Cl. H01M 4/62

(52) U.S. Cl. CPC H01M 4/624
USPC 429/211

(57) ABSTRACT

An electrode for non-aqueous electrolyte secondary batteries includes a current collector having principal surfaces facing each other and an active material layer which contains an active material, a binder, and a conductive material and which is placed on at least one of the principal surfaces of the current collector. The sum of the volume of the active material per unit area of the current collector and the volume of the conductive material per unit area of the current collector is 9.70×10⁻² cm³/cm² to 24.6×10⁻² cm³/cm², the volume of the active material being calculated from the average particle size D50 of the active material, the volume of the conductive material being calculated from the average particle size D50 of the conductive material. The pore volume of the active material layer per unit area of the current collector is 6.00×10⁻³ cm³/cm² to 20.0×10⁻³ cm³/cm².

### BACKGROUND OF THE INVENTION

1. Field of the Invention

The present invention relates to an electrode for non-aqueous electrolyte secondary batteries and a non-aqueous electrolyte secondary battery including the same.

2. Description of the Related Art

Lithium secondary batteries are practically used as non-aqueous electrolyte secondary batteries and are widely used. In recent years, the lithium secondary batteries have been attracting attention as compact portable electronic devices, vehicle-mounted devices, and high-capacity devices for photovoltaic systems or power storage including nighttime power storage.

Electrodes, such as positive electrodes and negative electrodes, for secondary batteries are manufactured in such a manner that a coating is formed by applying paste containing an active material and a binder to one or both surfaces of a current collector such as elongate metal foil and is dried and the dry coating is pressed, is wound, and is then cut into pieces with a predetermined width or length as required. The manufactured electrodes are stacked with separators interposed therebetween and are formed into a strip- or roll-shaped laminate, which is then inserted into a battery case. The paste contains a conductive material as required.

In the case of applying the above manufacturing method to a high-capacity secondary battery for power storage, the number of layers or turns needs to be increased in order to achieve high capacity. This results in that a current collector and a separator are used in large amounts, leading to a problem with an increase in manufacturing cost.

On the other hand, a method of achieving high capacity using an active material with a small particle size is under investigation. In this method, the reduction in particle size of the active material increases the amount of a conductive material used and unavoidably increases the amount of a binder used; hence, there is a problem with an increase in electrode resistance. In order to cope with this problem, for example, Japanese Unexamined Patent Application Publication No. 2010-15904 (hereinafter referred to as the patent document) discloses a method of suppressing the increase in resistance of an electrode by controlling the porosity and pore size of the electrode.

In the case where the amount of an active material is increased by increasing the thickness of a coating, a laminate can be manufactured with a reduced number of layers or turns and the number of current collectors or separators can be reduced; hence, manufacturing costs can be reduced. Furthermore, an active material with a small particle size need not be used and therefore no additional cost to produce such an active material with a small particle size is necessary. However, this way has a problem that the rate characteristic is reduced with an increase in coating thickness.

### SUMMARY OF THE INVENTION

Accordingly, it is an object of the present invention to provide an electrode, exhibiting an excellent rate characteristic even though the thickness of a coating is large, for non-aqueous electrolyte secondary batteries and a non-aqueous electrolyte secondary battery including the electrode.

The resistance of a battery depends on the resistance of materials forming the battery, the contact resistance between materials, particularly the contact resistance between an active material and a conductive material, the diffusion resistance of lithium ions, and the like. The resistance of the materials forming the electrode is constant. Therefore, in order to reduce the internal resistance of the battery, attempts are usually made to reduce the contact resistance between the active material and the conductive material and the diffusion resistance of the lithium ions. In particular, attempts are made to reduce the diffusion resistance of the lithium ions because the diffusion resistance of the lithium ions is greater than the contact resistance between the active material and the conductive material. If the amount of an electrolyte retained in the battery is increased by increasing the number of pores in the battery, the diffusion resistance of the lithium ions can be reduced. Therefore, attempts are generally made to reduce the diffusion resistance of the lithium ions by setting the porosity of the battery within a predetermined range as disclosed in the patent document. However, a conventional method has a problem that it is difficult to ensure a conductive path between the active material and the conductive material. In particular, if an attempt is made to increase the amount of the active material by increasing the thickness of a coating of the active material, it is difficult to ensure the porosity and the conductive path between the active material and the conductive material because the amount of the conductive material is increased depending on the amount of the active material.

The inventors have focused on the volume of an active material and the volume of a conductive material and have found that even if the thickness of a coating of the active material is increased, the internal resistance of a battery can be reduced and an excellent rate characteristic can be achieved in such a manner that the sum of the volume of the active material that is calculated from the average particle size D50 of the active material and the volume of the conductive material that is calculated from the average particle size D50 of the conductive material is maintained within an predetermined range, thereby completing the present invention.

An electrode, according to the present invention, for non-aqueous electrolyte secondary batteries includes a current collector having a pair of principal surfaces facing each other and also includes an active material layer which contains an active material, a binder, and a conductive material and which is placed on at least one of the principal surfaces of the current collector. The sum of the volume of the active material per unit area of the current collector and the volume of the conductive material per unit area of the current collector is 9.70×10⁻³ cm³/cm² to 24.6×10⁻³ cm³/cm², the volume of the active material being calculated from the average particle size D50 of the active material, the volume of the conductive material being calculated from the average particle size D50 of the conductive material. The pore volume of the active material layer per unit area of the current collector is 6.00×10⁻³ cm³/cm² to 20.0×10⁻³ cm³/cm².

A non-aqueous electrolyte secondary battery according to the present invention includes the above electrode.

According to the present invention, an electrode, exhibiting an excellent rate characteristic even though the thickness of a coating is large, for non-aqueous electrolyte secondary batteries and a non-aqueous electrolyte secondary battery including the electrode can be provided.

Effects of the present invention are probably due to the fact that maintaining the sum of the volume of an active material and the volume of a conductive material within a predetermined range allows the contact resistance between the active material and the conductive material to be reduced and allows a sufficient conductive path to be ensured and maintaining the pore volume of the active material layer within a predetermined range allows the diffusion resistance of lithium ions to be reduced.

### DESCRIPTION OF THE PREFERRED EMBODIMENTS

Embodiments of the present invention will now be described in detail.

An electrode, according to the present invention, for non-aqueous electrolyte secondary batteries includes a current collector having a pair of principal surfaces facing each other and also includes an active material layer which contains an active material, a binder, and a conductive material and which is placed on at least one of the principal surfaces of the current collector. The sum of the volume of the active material per unit area of the current collector and the volume of the conductive material per unit area of the current collector is 9.70×10⁻³ cm³/cm² to 24.6×10⁻³ cm³/cm², the volume of the active material being calculated from the average particle size D50 of the active material, the volume of the conductive material being calculated from the average particle size D50 of the conductive material. The pore volume of the active material layer per unit area of the current collector is 6.00×10⁻³ cm³/cm² to 20.0×10⁻³ cm³/cm².

In the present invention, the sum of the volume of the active material per unit area of the current collector and the volume of the conductive material per unit area of the current collector is preferably 9.70×10⁻³ cm³/cm² to 24.6×10⁻³ cm³/cm² and more preferably 10.3×10⁻³ cm³/cm² to 15.6×10⁻³ cm³/cm², the volume of the active material being calculated from the average particle size D50 of the active material, the volume of the conductive material being calculated from the average particle size D50 of the conductive material. When the sum of the volume of the active material per unit area of the current collector and the volume of the conductive material per unit area of the current collector is less than 9.70×10⁻³ cm³/cm², the number of electrodes used in a battery is large and the number of separators or current collectors is large. This leads to an increase in manufacturing cost of the battery and therefore is not preferred. When the sum of the volume of the active material per unit area of the current collector and the volume of the conductive material per unit area of the current collector is more than 24.6×10⁻³ cm³/cm², the rate characteristic is low. The term “average particle size D50” as used herein refers to a particle size at which the cumulative percentage of the particle volume accounts for 50%. The average particle size D50 can be measured using, for example, a laser diffraction/scattering particle size distribution analyzer.

The volume of the active material per unit area of the current collector is defined as the product of the volume (cm³) of a particle of the active material at the average particle size D50 and the number (particles/cm²) of particles of the active material per unit area of the current collector, the volume of the active material being calculated from the average particle size D50 of the active material, and can be calculated using the following equation:

Volume of active material per unit area of current collector (cm³/cm²)={(4/3π)×(radius of particle of active material (cm))³}×{(amount of active material per unit area of current collector (g/cm²))/(weight of particle of active material (g))} (I).

The volume of the conductive material per unit area of the current collector is defined as the product of the volume (cm³) of a particle of the conductive material at the average particle size D50 and the number (particles/cm²) of particles of the conductive material per unit area of the current collector, the volume of the conductive material being calculated from the average particle size D50 of the conductive material, and can be calculated using the following equation:

Volume of conductive material per unit area of current collector (cm³/cm²)={(4/3π)×(radius of particle of conductive material (cm))³}×{(amount of conductive material per unit area of current collector (g/cm²))/(weight of particle of conductive material (g))} (II).

The weight (g) of a particle of the active or conductive material can be determined in such a manner that a predetermined amount of measured powder is dispersed in a predetermined amount of a solvent and the number of particles in the solvent is measured using a particle size distribution analyzer or a particle counter.

The pore volume of the active material layer per unit area of the current collector is preferably 6.00×10⁻³ cm³/cm² to 20.0×10⁻³ cm³/cm² and more preferably 6.2×10⁻³ cm³/cm² to 17.2×10⁻³ cm³/cm². When the pore volume of the active material layer per unit area of the current collector is less than 6.00×10⁻³ cm³/cm² or is more than 20.0×10⁻³ cm³/cm², the rate characteristic is low.

The pore volume of the active material layer is defined as a difference obtained by subtracting the volumes of the active material, the binder, the conductive material, and a thickening agent, which are solid components of the active material layer, from the volume of the active material layer. The volume of the active material and the volume of the conductive material can be calculated using Equation (I) and Equation (II), respectively, as described above. The binder and thickening agent volume can be calculated using the following equation:

Binder and thickening agent volume per unit area of current collector (cm³/cm²)={(weight of binder per unit area of current collector (g/cm²))÷(true density of binder (g/cm³))}+{(weight of thickening agent per unit area of current collector (g/cm²))÷(true density of thickening agent (g/cm³))} (III).

The electrode can be used as both a positive electrode and a negative electrode.

### Positive Electrode

A positive electrode active material used is a lithium-metal composite oxide. Examples of the lithium-metal composite oxide include LiCoO₂, LiNiO₂, LiFeO₂, LiMnO₂, LiMn₂O₄, Li₂MnO₃, LiCoPO₄, LiNiPO₄, LiMnPO₄, and LiFePO₄ (iron lithium phosphate). LiFePO₄ is preferred because LiFePO₄ is high in safety and is low in cost. Iron lithium phosphate includes compounds in which different elements are substituted for an iron site and a phosphorus site. An element substitutive for the iron site is at least one selected from the group consisting of Zr, Sn, Y, and Al. An element substitutive for the phosphorus site is Si.

The positive electrode active material can be produced using an arbitrary combination of carbonates, hydroxides, chlorides, sulfates, acetates, oxides, oxalates, nitrates, and the like of elements as a starting material. Among these compounds, a carbonate, a hydroxide, an acetate, an oxide, and an oxalate are preferred from the viewpoint that gas which may possibly affect synthesis is unlikely to be produced during calcination. In particular, the carbonate, the hydroxide, the acetate, and the oxalate, which are degraded at low temperature, that is, which can be synthesized at low temperature, are preferred.

From the viewpoint that a homogeneous solution is readily prepared in an air atmosphere by a liquid phase process and the viewpoint of low cost, a weak-acid salt such as a carbonate, an acetate, or an oxalate or a strong-acid salt such as a nitrate or a chloride is preferred. In particular, an acetate or a nitrate is preferred.

Examples of a process that can be used to produce the positive electrode active material include solid phase processes, sol-gel processes, melt-quenching processes, mechanochemical processes, coprecipitation processes, hydrothermal processes, and spray pyrolysis processes. Since it is important for single-phase synthesis that the state of an uncalcined mixture is uniform and the size of particles is small, a sol-gel process, coprecipitation process, hydrothermal process, and spray pyrolysis process which are liquid phase processes are preferred. In terms of yield, the sol-gel process, the coprecipitation process, and the hydrothermal process are more preferred. The sol-gel process is further more preferred.

### Method of Manufacturing Positive Electrode

A positive electrode is prepared in such a manner that paste is obtained by mixing and dispersing the positive electrode active material, the conductive material, the binder, and the thickening agent using a solvent, is applied to one or both surfaces of the current collector, and is then dried. The solvent used may be an organic solvent such as N-methyl-2-pyrrolidone, toluene, cyclohexane, dimethylformamide, dimethylacetamide, methyl ethyl ketone, methyl acetate, methyl acrylate, diethyltriamine, N,N-dimethylaminopropylamine, ethylene oxide, tetrahydrofuran, or the like. When the binder is water-soluble, the solvent may be water. When the solvent is water, the pH of the paste is preferably 5 or more and more preferably 8 or more. This is because when the pH of the paste is less than 5, a battery including the obtained positive electrode has no enhanced cycle characteristic.

Examples of the conductive material include acetylene black, carbon black, natural graphite, and synthetic graphite. These materials can be used alone or in combination.

For the proportion of the conductive material to positive electrode active material contained in a coating, the amount of the conductive material is preferably two parts to 20 parts by weight and more preferably four parts to ten parts by weight with respect to 100 parts by weight of the positive electrode active material. When the amount of the conductive material is less than two parts by weight, the contact resistance between the positive electrode active material and the current collector is large, which is not preferred. When the amount of the conductive material is more than 20 parts by weight, the effect of reducing the contact resistance therebetween is not appropriate to the amount of the added conductive material and costs are increased, which is not preferred.

Examples of the binder include polytetrafluoroethylene, polyvinylidene fluoride, polyvinyl chloride, ethylene-propylene-diene copolymers, styrene-butadiene rubber, acrylonitrile-butadiene rubber, fluoro-rubber, polyvinyl acetate, polymethyl methacrylate, polyethylene, nitrocellulose, aqueous binder emulsions, fluorine-modified styrene-butadiene rubber, olefinic copolymers, and acid-modified olefinic copolymers. In the case of using an aqueous binder emulsion, a thickening agent such as carboxymethylcellulose (hereinafter simply referred to as CMC), polyvinyl alcohol, or polyvinylpyrrolidone can be used.

The current collector, which is used in the positive electrode, has a pair of principal surfaces facing each other and may be a sheet-shaped or foil-shaped metal current collector. Examples of a material that can be used to form the current collector include aluminum, nickel, chromium, and alloys of these metals. Aluminum is preferred.

The mass per unit area of the positive electrode active material applied to a surface of the current collector is 15 mg/cm² or more and more preferably 15 mg/cm² to 38 mg/cm² as the thickness of a coating of the positive electrode is expressed in terms of the amount of the positive electrode active material applied to the current collector. When the mass per unit area thereof is less than 15 mg/cm², the number of electrodes used in a battery is large, the number of separators or current collectors used therein is large, and therefore the cost of manufacturing the battery is high, which is not preferred. The amount of the positive electrode active material applied to a surface of the current collector is twice the amount of the positive electrode active material applied to both surfaces of the current collector. The mass per unit area of the positive electrode active material applied to both surface of the current collector is 30 mg/cm² or more and more preferably 30 mg/cm² to 76 mg/cm².

### Negative Electrode

A negative electrode active material used may be a known material. A material with a lithium insertion/deinsertion potential close to the deposition-dissolution potential of metallic lithium is preferably used to configure a high-energy density battery. A typical example of such a material is a granular (scaly, massive, fibrous, whisker-like, spherical, or particulate) carbon material such as natural or synthetic graphite.

Synthetic graphite may be one obtained by graphitizing meso-carbon micro-beads, a mesophase pitch powder, an isotropic pitch powder, or the like. Graphite particles coated with amorphous carbon can be used. Among these materials, natural graphite is preferred because natural graphite is inexpensive, has a potential close to the oxidation/reduction potential of lithium, and can be used to configure a high-energy density battery.

Usable examples of the negative electrode active material include lithium-transition metal oxides, lithium-transition metal nitrides, transition metal oxides, and silicon oxide. Among these materials, Li₄Ti₅O₁₂ is preferred because Li₄Ti₅O₁₂ has high potential flatness and is small in volume change due to charge or discharge.

### Method of Manufacturing Negative Electrode

A negative electrode can be prepared by a known process. The negative electrode can be prepared in such a manner that, for example, the negative electrode active material, the binder, and the conductive material are mixed, the obtained mixture is formed into a sheet, and the sheet is press-bonded to the current collector or a mesh current collector which is made of, for example, stainless steel or copper. The negative electrode, as well as the positive electrode, can be prepared using water as a solvent. In this case, paste is obtained by mixing and dispersing the negative electrode active material, the conductive material, and the binder using water and is applied to the current collector. A thickening agent may be added to the paste as required.

The mass per unit area of the negative electrode active material applied to a surface of the current collector is 7 mg/cm² or more and more preferably 7 mg/cm² to 20 mg/cm² as the thickness of a coating of the negative electrode is expressed in terms of the amount of the positive electrode active material applied to the current collector. When the mass per unit area thereof is less than 7 mg/cm², the number of electrodes used in a battery is large, the number of separators or current collectors used therein is large, and therefore the cost of manufacturing the battery is high, which is not preferred. The amount of the positive electrode active material applied to a surface of the current collector is twice the amount of the positive electrode active material applied to both surfaces of the current collector. The mass per unit area of the positive electrode active material applied to both surface of the current collector is 14 mg/cm² or more and more preferably 14 mg/cm² to 40 mg/cm².

The current collector, which is used in the positive electrode, has a pair of principal surfaces facing each other and may be a sheet-shaped or foil-shaped metal current collector. Examples of a material that can be used to form the current collector include aluminum, nickel, and copper. Copper is preferred.

### Non-Aqueous Electrolyte

Examples of a non-aqueous electrolyte that can be used herein include organic electrolytes, gelatinous electrolytes, polymeric solid electrolytes, inorganic solid electrolytes, and molten-salt electrolytes.

Examples of an organic solvent contained in an organic electrolyte solution include cyclic carbonates such as propylene carbonate (PC), ethylene carbonate (EC), and butylene carbonate; linear carbonates such as dimethyl carbonate (DMC), diethyl carbonate (DEC), ethyl methyl carbonate, and dipropyl carbonate; lactones such as γ-butyrolactone (GBL) and γ-valerolactone; furans such as tetrahydrofuran and 2-methyltetrahydrofuran; ethers such as diethyl ether, 1,2-dimethoxyethane, 1,2-diethoxyethane, ethoxymethoxyethane, and dioxane; dimethyl sulfoxide; sulfolane; methylsulfolane; acrylonitrile; methyl formate; and methyl acetate. These compounds can be used alone or in combination.

The cyclic carbonates, such as PC, EC, and butylene carbonate, are high-boiling point solvents and are preferably used in combination with GBL.

Examples of an electrolyte salt contained in the organic electrolyte solution include lithium salts such as lithium borofluoride (LiBF₄), lithium hexafluorophosphate (LiPF₆), lithium trifluoromethanesulfonate (LiCF₃SO₃), lithium trifluoroacetate (LiCF₃COO), and lithium bis(trifluoromethanesulfon) imide (LiN(CF₃SO₂)₂). These compounds can be used alone or in combination. The salt concentration of the organic electrolyte solution is preferably 0.5 mol/L to 3 mol/L.

### Separator

A separator used herein may be made of a known material such as a porous material or unwoven fabric. A material for the separator is preferably one that is not dissolved in or swollen with the organic solvent, which is contained in the organic electrolyte solution. Examples of such a material include polyesters, polyolefins such as polyethylene and polypropylene, polyethers, and glass fibers.

### Other Members

Other members such as a battery case may be made of known various materials and are not particularly limited.

### Method of Manufacturing Secondary Battery

A secondary battery includes, for example, a laminate including a positive electrode, a negative electrode, and a separator interposed therebetween. The laminate may have, for example, a strip shape in plan view. In the case of preparing a cylindrical or flat battery, the laminate may be into a roll.

The laminate or a plurality of laminates are inserted into a battery case. In usual, the positive electrode and the negative electrode are connected to external conductive terminals of the secondary battery. Thereafter, the battery case is hermetically sealed in order to shield the positive electrode, the negative electrode, and the separator from air.

When the secondary battery is cylindrical, a method of hermetically sealing the battery case is usually such a way that a lid having a resin packing is fit into an opening in the battery case and the battery case and the lid are swaged or the lid is soldered to the opening. When the secondary battery is rectangular, the following way can be used: such a way that a lid called a sealing plate made of metal is attached to the opening and is soldered thereto. Besides these ways, the following ways can be used: a way to hermetically seal the battery case with a binder and a way to bolt the battery case using a gasket. Furthermore, the following way can be used: a way to hermetically seal the battery case with a laminate film prepared by applying a thermoplastic resin to a metal foil. A port for electrolyte injection may be provided in the battery case before sealing. In the case of using an organic electrolyte solution, the organic electrolyte solution is injected into the port and the port is then sealed. Generated gas may be removed by electrification before sealing. In the case of manufacturing a large-size battery with a capacity of 20 Ah to 500 Ah per cell, a plurality of ports for electrolyte solution injection may be provided in the battery case. For example, one of the ports is used to inject an electrolyte solution and the other ports may be used to remove gas. When the capacity of the battery is less than 20 Ah, it is difficult to reduce the cost of a power storage system. This is not preferred. When the capacity thereof is more than 500 Ah, safety is low even if iron lithium phosphate is used as a positive electrode active material. This is not preferred.

### EXAMPLES

The present invention is further described below in detail with reference to examples. The present invention is not limited to the examples.

### Examples 1 to 4 and Comparative Examples 1 to 3

### Preparation of Positive Electrodes

A positive electrode active material A (g), a conductive material B (g), a binder C (g), an aqueous thickening agent solution D (g), and ion-exchanged water E (g) were mixed together at room temperature using a mixer, FILMIX 80-40, available from PRIMIX Corporation, whereby an aqueous paste was obtained.

The aqueous paste was applied to both surfaces of each rolled aluminum foil with a thickness of 20 μm using a die coater and was dried at 100° C. for 30 minutes in air, followed by pressing, whereby a positive electrode with a coated surface size of 30 cm×15 cm was obtained.

Tables 1 and 2 show the weight of the positive electrode active material per unit area, the volume of the positive electrode active material that is calculated from the average particle size D50 of the positive electrode active material, the volume of the conductive material that is calculated from the average particle size D50 of the conductive material, and the pore volume of each positive electrode. The average particle size D50 was determined using a laser diffraction/scattering particle size distribution analyzer, LMS-2000e, available from Seishin Enterprise Co., Ltd.

### Preparation of Negative Electrodes

A negative electrode active material a (g), a conductive material b (g), a binder c (g), an aqueous thickening agent solution c (g), and ion-exchanged water e (g) were mixed together at room temperature using a twin-screw planetary mixer available from PRIMIX Corporation, whereby an aqueous paste was obtained.

The aqueous paste was applied to both surfaces of each rolled copper foil with a thickness of 10 μm using a die coater and was dried at 100° C. for 30 minutes in air, followed by pressing, whereby a negative electrode with a coated surface size of 30.4 cm×15.4 cm was obtained.

Tables 1 and 2 show the weight of each active material per unit area, the volume of the active material that is calculated from the average particle size D50 of the active material, the volume of the conductive material that is calculated from the average particle size D50 of the conductive material, and the pore volume of each electrode.

### Preparation of Batteries

The prepared positive and negative electrodes were dried at 130° C. for 24 hours under reduced pressure and were then put into a glove box in an Ar atmosphere. Each battery was assembled at room temperature in the glove box as described below. A polyethylene (PE) porous film having a length of 30.4 cm, a width of 15.4 cm, a thickness of 25 μm, and a pore volume of 55% was provided on one of the negative electrodes, one of the positive electrodes was provided thereon, and another PE porous film was provided thereon, whereby each laminate including six of the negative electrodes, five of the positive electrodes, and ten PE porous films interposed therebetween was prepared. Ni leads were ultrasonically welded to the six negative electrodes and Al leads were ultrasonically welded to the five positive electrodes. The laminate was inserted into an Al-laminated bag, three sides of which were thermally fused. An electrolyte solution was prepared by dissolving LiPF₆ in a solvent prepared by mixing ethylene carbonate (EC) and diethyl carbonate (DEC) at a volume ratio of 1:2 so as to have a concentration of 1 mol/L and was poured into a cell. Each lead was withdrawn from the Al-laminated bag and the last one side of the Al-laminated bag was thermally fused, whereby a battery was obtained. The amount of the poured electrolyte solution and the battery capacity are shown in Table 1. The amount of the poured electrolyte solution was appropriately determined depending on the thickness of an electrode used in each battery such that the positive electrodes, negative electrodes, and separators of the battery were sufficiently impregnated with the electrolyte solution.

### Measurement of Battery Capacity

The capacity (hereinafter referred to as 0.1 C capacity) of each battery was determined in such a manner that the battery was charged to 3.6 V at 0.1 C constant current and was discharged to 2 V at 0.1 C constant current. The rate characteristic was defined by the formula (1.0 C capacity)/(0.1 C capacity). The 1.0 C capacity of the battery was determined in such a manner that the battery was charged to 3.6 V at 0.1 C constant current and was discharged to 2 V at 1.0 C constant current. Results are Tables 1 and 2.

TABLE 1

| | | | | | | | Electrode | | | | |
|---|---|---|---|---|---|---|---|---|---|---|---|
| | | | | | | | | | Sum of | | |
| | | | | | | | | | active | | |
| | | | | | | | | | material | | |
| | | | | | | | Amount of | | volume and | Rate | |
| | | | | Material properties | | | material | Volume | conductive | characteristic | |
| | | | | | Average | | applied to | calculated | material | Pore | |
| | | | | True | particle | Slurry | both | from D50 | volume | volume | 1 C/ |
| | | | | density | size D50 | Weight | surfaces | ×10⁻³ | ×10⁻³ | ×10⁻³ | 0.1 C |
| | | | Materials | (g/cm³) | (μm) | (g) | (mg/cm³) | (cm³/cm²) | (cm³/cm²) | (cm³/cm²) | % |
| Example | Positive | A | Iron lithium phosphate | 3.45 | 9.2 | 100 | 44.0 | 12.75 | 14.22 | 6.30 | 90.1 |
| 1 | electrode | | (available from Sumitomo | | | | | | | | |
| | | | Osaka Cement Co., Ltd.) | | | | | | | | |
| | | B | Acetylene black (available | 1.8 | 0.035 | 6 | 2.6 | 1.47 | | | |
| | | | from Denki Kagaku Kogyo | | | | | | | | |
| | | | Kabushiki Kaisha) | | | | | | | | |
| | | C | Binder (a solid content of | | | 27 | 3.6 | | | | |
| | | | 29.9%, available from JSR | | | | | | | | |
| | | | Corporation) | | | | | | | | |
| | | D | CMC (available from | | | 1.2 | 0.5 | | | | |
| | | | Dai-ichi Kogyo Seiyaku Co., | | | | | | | | |
| | | | Ltd.) | | | | | | | | |
| | | E | Ion-exchanged water | | | 78.8 | 0 | | | | |
| | Negative | a | Natural graphite (available | | | 100 | 24.0 | | | | |
| | electrode | | from Hitachi Chemical Co., | | | | | | | | |
| | | | Ltd.) | | | | | | | | |
| | | b | | | | | | | | | |
| | | c | Binder (a solid content of | | | 2 | 0.2 | | | | |
| | | | 40.1%, available from ZEON | | | | | | | | |
| | | | Corporation) | | | | | | | | |
| | | d | CMC (available from Daicel | | | 1 | 0.2 | | | | |
| | | | Chemical Industries Ltd.) | | | | | | | | |
| | | e | Ion-exchanged water | | | 100 | 0 | | | | |
| Example | Positive | A | Iron lithium phosphate | 3.45 | 9.2 | 100 | 44.0 | 12.75 | 14.22 | 7.02 | 95.3 |
| 2 | electrode | | (available from Sumitomo | | | | | | | | |
| | | | Osaka Cement Co., Ltd.) | | | | | | | | |
| | | B | Acetylene black (available | 1.8 | 0.035 | 6 | 2.6 | 1.47 | | | |
| | | | from Denki Kagaku Kogyo | | | | | | | | |
| | | | Kabushiki Kaisha) | | | | | | | | |
| | | C | Binder (a solid content of | | | 27 | 3.6 | | | | |
| | | | 29.9%, available from JSR | | | | | | | | |
| | | | Corporation) | | | | | | | | |
| | | D | CMC (available from | | | 1.2 | 0.5 | | | | |
| | | | Dai-ichi Kogyo Seiyaku Co., | | | | | | | | |
| | | | Ltd.) | | | | | | | | |
| | | E | Ion-exchanged water | | | 78.8 | 0 | | | | |
| | Negative | a | Natural graphite (available | | | 100 | 24.0 | | | | |
| | electrode | | from Hitachi Chemical Co., | | | | | | | | |
| | | | Ltd.) | | | | | | | | |
| | | b | | | | | | | | | |
| | | c | Binder (a solid content of | | | 2 | 0.2 | | | | |
| | | | 40.1%, available from ZEON | | | | | | | | |
| | | | Corporation) | | | | | | | | |
| | | d | CMC (available from Daicel | | | 1 | 0.2 | | | | |
| | | | Chemical Industries Ltd.) | | | | | | | | |
| | | e | Ion-exchanged water | | | 100 | 0 | | | | |
| Example | Positive | A | Iron lithium phosphate | 3.45 | 9.2 | 100 | 44.0 | 12.75 | 14.22 | 15.72 | 95.8 |
| 3 | electrode | | (available from Sumitomo | | | | | | | | |
| | | | Osaka Cement Co., Ltd.) | | | | | | | | |
| | | B | Acetylene black (available | 1.8 | 0.035 | 6 | 2.6 | 1.47 | | | |
| | | | from Denki Kagaku Kogyo | | | | | | | | |
| | | | Kabushiki Kaisha) | | | | | | | | |
| | | C | Binder (a solid content of | | | 27 | 3.6 | | | | |
| | | | 29.9%, available from JSR | | | | | | | | |
| | | | Corporation) | | | | | | | | |
| | | D | CMC (available from | | | 1.2 | 0.5 | | | | |
| | | | Dai-ichi Kogyo Seiyaku Co., | | | | | | | | |
| | | | Ltd.) | | | | | | | | |
| | | E | Ion-exchanged water | | | 78.8 | 0 | | | | |
| | Negative | a | Natural graphite (available | | | 100 | 24.0 | | | | |
| | electrode | | from Hitachi Chemical Co., | | | | | | | | |
| | | | Ltd.) | | | | | | | | |
| | | b | | | | | | | | | |
| | | c | Binder (a solid content of | | | 2 | 0.2 | | | | |
| | | | 40.1%, available from ZEON | | | | | | | | |
| | | | Corporation) | | | | | | | | |
| | | d | CMC (available from Daicel | | | 1 | 0.2 | | | | |
| | | | Chemical Industries Ltd.) | | | | | | | | |
| | | e | Ion-exchanged water | | | 100 | 0 | | | | |
| Example | Positive | A | Iron lithium phosphate | 3.45 | 9.2 | 100 | 44.0 | 12.75 | 14.22 | 19.93 | 90.6 |
| 4 | electrode | | (available from Sumitomo | | | | | | | | |
| | | | Osaka Cement Co., Ltd.) | | | | | | | | |
| | | B | Acetylene black (available | 1.8 | 0.035 | 6 | 2.6 | 1.47 | | | |
| | | | from Denki Kagaku Kogyo | | | | | | | | |
| | | | Kabushiki Kaisha) | | | | | | | | |
| | | C | Binder (a solid content of | | | 27 | 3.6 | | | | |
| | | | 29.9%, available from JSR | | | | | | | | |
| | | | Corporation) | | | | | | | | |
| | | D | CMC (available from | | | 1.2 | 0.5 | | | | |
| | | | Dai-ichi Kogyo Seiyaku Co., | | | | | | | | |
| | | | Ltd.) | | | | | | | | |
| | | E | Ion-exchanged water | | | 78.8 | 0 | | | | |
| | Negative | a | Natural graphite (available | | | 100 | 24.0 | | | | |
| | electrode | | from Hitachi Chemical Co., | | | | | | | | |
| | | | Ltd.) | | | | | | | | |
| | | b | | | | | | | | | |
| | | c | Binder (a solid content of | | | 2 | 0.2 | | | | |
| | | | 40.1%, available from ZEON | | | | | | | | |
| | | | Corporation) | | | | | | | | |
| | | d | CMC (available from Daicel | | | 1 | 0.2 | | | | |
| | | | Chemical Industries Ltd.) | | | | | | | | |
| | | e | Ion-exchanged water | | | 100 | 0 | | | | |

TABLE 2

| | | | | | | | Electrode | | | | |
|---|---|---|---|---|---|---|---|---|---|---|---|
| | | | | | | | | | Sum of | | |
| | | | | | | | | | active | | |
| | | | | | | | | | material | | |
| | | | | | | | Amount of | | volume and | | Rate |
| | | | | Material properties | | | material | Volume | conductive | | charac- |
| | | | | | Average | | applied to | calculated | material | Pore | teristic |
| | | | | True | particle | Slurry | both | from D50 | volume | volume | 1 C/ |
| | | | | density | size D50 | Weight | surfaces | ×10⁻³ | ×10⁻³ | ×10⁻³ | 0.1 C |
| | | | Materials | (g/cm³) | (μm) | (g) | (mg/cm³) | (cm³/cm²) | (cm³/cm²) | (cm³/cm²) | % |
| Com- | Positive | A | Iron lithium phosphate | 3.45 | 9.2 | 100 | 40.8 | 11.83 | 13.19 | 5.85 | 81.2 |
| parative | electrode | | (available from Sumitomo | | | | | | | | |
| Example | | | Osaka Cement Co., Ltd.) | | | | | | | | |
| 1 | | B | Acetylene black (available | 1.8 | 0.035 | 6 | 2.4 | 1.36 | | | |
| | | | from Denki Kagaku Kogyo | | | | | | | | |
| | | | Kabushiki Kaisha) | | | | | | | | |
| | | C | Binder (a solid content of | | | 27 | 3.3 | | | | |
| | | | 29.9%, available from JSR | | | | | | | | |
| | | | Corporation) | | | | | | | | |
| | | D | CMC (available from | | | 1.2 | 0.5 | | | | |
| | | | Dai-ichi Kogyo Seiyaku Co., | | | | | | | | |
| | | | Ltd.) | | | | | | | | |
| | | E | Ion-exchanged water | | | 78.8 | 0 | | | | |
| | Negative | a | Natural graphite (available | | | 100 | 24.0 | | | | |
| | electrode | | from Hitachi Chemical Co., | | | | | | | | |
| | | | Ltd.) | | | | | | | | |
| | | b | | | | | | | | | |
| | | c | Binder (a solid content of | | | 2 | 0.2 | | | | |
| | | | 40.1%, available from ZEON | | | | | | | | |
| | | | Corporation) | | | | | | | | |
| | | d | CMC (available from Daicel | | | 1 | 0.2 | | | | |
| | | | Chemical Industries Ltd.) | | | | | | | | |
| | | e | Ion-exchanged water | | | 100 | 0 | | | | |
| Com- | Positive | A | Iron lithium phosphate | 3.45 | 9.2 | 100 | 44.0 | 12.75 | 14.22 | 26.93 | 88.2 |
| parative | electrode | | (available from Sumitomo | | | | | | | | |
| Example | | | Osaka Cement Co., Ltd.) | | | | | | | | |
| 2 | | B | Acetylene black (available | 1.8 | 0.035 | 6 | 2.6 | 1.47 | | | |
| | | | from Denki Kagaku Kogyo | | | | | | | | |
| | | | Kabushiki Kaisha) | | | | | | | | |
| | | C | Binder (a solid content of | | | 27 | 3.6 | | | | |
| | | | 29.9%, available from JSR | | | | | | | | |
| | | | Corporation) | | | | | | | | |
| | | D | CMC (available from | | | 1.2 | 0.5 | | | | |
| | | | Dai-ichi Kogyo Seiyaku Co., | | | | | | | | |
| | | | Ltd.) | | | | | | | | |
| | | E | Ion-exchanged water | | | 78.8 | 0 | | | | |
| | Negative | a | Natural graphite (available | | | 100 | 24.0 | | | | |
| | electrode | | from Hitachi Chemical Co., | | | | | | | | |
| | | | Ltd.) | | | | | | | | |
| | | b | | | | | | | | | |
| | | c | Binder (a solid content of | | | 2 | 0.2 | | | | |
| | | | 40.1%, available from ZEON | | | | | | | | |
| | | | Corporation) | | | | | | | | |
| | | d | CMC (available from Daicel | | | 1 | 0.2 | | | | |
| | | | Chemical Industries Ltd.) | | | | | | | | |
| | | e | Ion-exchanged water | | | 100 | 0 | | | | |
| Com- | Positive | A | Iron lithium phosphate | 3.45 | 9.2 | 89 | 79.0 | 22.90 | 26.84 | 19.13 | 65.5 |
| parative | electrode | | (available from Mitsui | | | | | | | | |
| Example | | | Engineering & Shipbuilding | | | | | | | | |
| 3 | | | Co., Ltd.) | | | | | | | | |
| | | B | Acetylene black (available | 1.8 | 0.035 | 8 | 7.1 | 3.95 | | | |
| | | | from Denki Kagaku Kogyo | | | | | | | | |
| | | | Kabushiki Kaisha) | | | | | | | | |
| | | C | Binder (a solid content of | | | 65.1 | 11.0 | | | | |
| | | | 19.0%, available from Mitsui | | | | | | | | |
| | | | Chemicals, Inc.) | | | | | | | | |
| | | D | Thickening agent (a solid | | | 32.6 | 4.2 | | | | |
| | | | content of 14.4%, available | | | | | | | | |
| | | | from Mitsui Chemicals, Inc.) | | | | | | | | |
| | | E | Ion-exchanged water | | | 37.3 | 0 | | | | |
| | Negative | a | Natural graphite (available | | | 100 | 33.0 | | | | |
| | electrode | | from Hitachi Chemical Co., | | | | | | | | |
| | | | Ltd.) | | | | | | | | |
| | | b | | | | | | | | | |
| | | c | Binder (a solid content of | | | 3 | 0.4 | | | | |
| | | | 40.1%, available from ZEON | | | | | | | | |
| | | | Corporation) | | | | | | | | |
| | | d | CMC (available from Daicel | | | 1 | 0.3 | | | | |
| | | | Chemical Industries Ltd.) | | | | | | | | |
| | | e | Ion-exchanged water | | | 100 | 0 | | | | |

### Results

As shown in Tables 1 and 2, in Examples 1 to 4, a rate characteristic of more than 90% is obtained. However, in Comparative Example 1, in which the pore volume is less than 6.00×10⁻³ cm³/cm², and Comparative Example 2, in which the pore volume is more than 20.0×10⁻³ cm³/cm², the rate characteristic is about 80%. In Comparative Example 3, in which the sum of the volume of the active material and the volume of the conductive material is more than 24.6×10⁻³ cm³/cm², the rate characteristic is very low, 65.6%. As is clear from the above results, a non-aqueous electrolyte secondary battery having an excellent rate characteristic can be provided using an electrode according to the present invention.

What is claimed is:

1. An electrode for non-aqueous electrolyte secondary batteries, comprising:
a current collector having a pair of principal surfaces facing each other; and
an active material layer which contains an active material, a binder, and a conductive material and which is placed on at least one of the principal surfaces of the current collector,
wherein the sum of the volume of the active material per unit area of the current collector and the volume of the conductive material per unit area of the current collector is 9.70×10⁻³ cm³/cm² to 24.6×10⁻³ cm³/cm², the volume of the active material being calculated from the average particle size D50 of the active material, the volume of the conductive material being calculated from the average particle size D50 of the conductive material, and the pore volume of the active material layer per unit area of the current collector is 6.00×10⁻³ cm³/cm² to 20.0×10⁻³ cm³/cm².

2. The electrode according to claim 1, comprising active material layers placed on both of the principal surfaces of the current collector, wherein the weight of the active material layers per unit area of the current collector is 30 mg/cm² to 76 mg/cm².

3. The electrode according to claim 1, wherein the electrode is a positive electrode and the active material is iron lithium phosphate.

4. A non-aqueous electrolyte secondary battery comprising the electrode according to claim 1.
